(19) United States
(12) Patent Application Publication
(10) Pub. No.: US 2022/0198093 A1
(43) Pub. Date: Jun. 23, 2022

(54) DEVICE, METHOD AND COMPUTER PROGRAM PRODUCT FOR CHECKING STABILITY

(71) Applicant: LEGO A/S, Billund (DK)

(72) Inventors: Hyeonho Park, Billund (DK); Yeon-mi YEO, Billund (DK)

(21) Appl. No.: 17/602,742

(22) PCT Filed: Apr. 10, 2020
(86) PCT No.: PCT/EP2020/060354

§ 371 Date: Oct. 8, 2021

(30) Foreign Application Priority Data
Apr. 12, 2019 (KR) 10-2019-0043153

(51) Int. Cl. G06F 30/17; G06T 19/20; G06F 30/12

(52) U.S. Cl. CPC G06F 30/17; G06T 19/20; G06F 2111/18; G06T 2219/2008; G06F 30/12

(57) ABSTRACT

The present disclosure relates to a method for checking connection stability of a plurality of assembling elements disposed in a virtual space, each of the assembling elements having at least one coupling part complementarily coupled to another coupling part and being connected to another assembling element through the coupling part. A connection stability checking method includes: assigning preset weight information to the assembling element; calculating a coupling power of the coupling part in consideration of a coupling type and a coupling number of the coupling part; and determining connection stability between the assembling element and another assembling element on the basis of the coupling power and the weight information assigned to the assembling element.

### TECHNICAL FIELD

The present disclosure relates to a stability checking device, method, and computer program product and, more specifically, to a stability checking device, method, and computer program product which provide information relating to stability relating to an assembling toy and assembling elements used for assembling the assembling toy.

### BACKGROUND ART

Assembling toys such as Legos have been beloved as playthings for decades. Assembling toys having various shapes can be made by assembling various assembling elements, which have been standardized and have high interchangeability, and thus assembling toys are very popular not only with young children but also with adults.

Recently, assembling toy users are increasingly demanding to develop their own designs beyond conventionally assembling an assembling toy in a shape predetermined by a seller. In relation to this, in order to minimize trial and error and inconvenience occurring with directly assembling an assembling toy in an actual space, programs that enable a user to virtually assemble assembling elements are being developed.

### DISCLOSURE OF THE INVENTION

### Technical tasks to be solved by the invention

A task of the present invention is to provide a method for checking a connection stability on the basis of a coupling power of a coupling part connecting an assembling element and a weight of the assembling element.

A further task of the present invention is to check a balance stability on the basis of a weight of an assembling element and location data of the assembling element.

Another task of the present invention is to check the stability of an assembling element in a virtual space before actual assembling, to enhance user convenience.

Tasks to be achieved through the present invention are not limited to the aforementioned tasks, and other tasks that have not been mentioned may be clearly understood by those of ordinary skill in the art from the present disclosure and the accompanying drawings.

### Technical solution

An aspect of the present disclosure may provide a method for checking connection stability of a plurality of assembling elements disposed in a virtual space, each of the assembling elements having at least one coupling part complementarily coupled to another coupling part and being connected to another assembling element through the coupling part. The method includes: assigning preset weight information to the assembling element; calculating a coupling power of the coupling part in consideration of a coupling type and a coupling number of the coupling part; and determining connection stability between the assembling element and said another assembling element on the basis of the coupling power and the weight information assigned to the assembling element.

Another aspect of the present disclosure may provide a method for checking balance stability of a plurality of assembling elements disposed in a virtual space, each of the assembling elements having at least one coupling part complementarily coupled to another coupling part and being connected to another assembling element through the coupling part. The method includes: calculating a mass distribution assigned to an assembling toy composed of the assembling element and all other assembling elements connected to the assembling element; and determining balance stability of the assembling toy on the basis of the mass distribution.

Solutions of the present disclosure are not limited to the above described solutions, and other solutions that have not been mentioned may be clearly understood by those of ordinary skill in the art from the present disclosure and the accompanying drawings.

### Advantageous effects

According to the present disclosure, the connection stability of a plurality of assembling elements can be checked on the basis of a coupling power of a coupling part connecting an assembling element and a weight of the assembling element.

Further, according to the present disclosure, balance stability of a plurality of assembling elements can be checked on the basis of a weight of an assembling element and location data of the assembling element.

Furthermore, according to the present disclosure, user convenience can be enhanced by checking stability of an assembling element in a virtual space before actual assembling.

Effects of the present disclosure are not limited to the above described effects, and other effects that have not been mentioned may be clearly understood by those of skill in the art from the present disclosure and the accompanying drawings.

### BRIEF DESCRIPTION OF DRAWINGS

FIG. 1 is a diagram relating to a system that processes a virtual space according to an embodiment of the present disclosure.

FIG. 2 is a diagram illustrating a virtual space according to an embodiment of the present disclosure.

FIG. 3 is a diagram illustrating an assembling element palette according to an embodiment of the present disclosure.

FIG. 4 is a diagram that illustrates disposing an assembling element in a virtual space according to an embodiment of the present disclosure.

FIG. 5 is a diagram that illustrates moving an assembling element or adjusting the posture of the assembling element in a virtual space according to an embodiment of the present disclosure.

FIGS. 6 and 7 are diagrams that illustrate connecting assembling elements in a virtual space according to an embodiment of the present disclosure.

FIG. 8 is a diagram relating to assembling elements and an assembling toy according to an embodiment of the present disclosure.

FIG. 9 is a diagram illustrating various types of assembling elements according to an embodiment of the present disclosure.

FIGS. 10 and 11 are diagrams illustrating examples of coupling of coupling parts according to an embodiment of the present disclosure.

FIG. 12 is a diagram relating to weight values of assembling elements according to an embodiment of the present disclosure.

FIGS. 13 and 14 are diagrams relating to coupling power values between coupling parts according to an embodiment of the present disclosure.

FIG. 15 is a diagram illustrating an example of a coupled state between coupling parts according to an embodiment of the present disclosure.

FIGS. 16 and 17 are diagrams relating to a determination of balance stability of an assembling toy according to an embodiment of the present disclosure.

FIG. 18 is another diagram relating to a determination of balance stability of an assembling toy according to an embodiment of the present disclosure.

FIG. 19 is yet another diagram relating to a determination of balance stability of an assembling toy according to an embodiment of the present disclosure.

FIGS. 20 and 21 are diagrams illustrating a coupling point according to an embodiment of the present disclosure.

FIGS. 22 to 24 are diagrams illustrating grouping of assembling elements according to an embodiment of the present disclosure.

FIG. 25 is a diagram illustrating displaying assembly stability by using visual information according to an embodiment of the present disclosure.

FIG. 26 is a flowchart relating to a stability checking method according to an embodiment of the present disclosure.

FIG. 27 is a flowchart of a first embodiment of a balance stability checking method according to the present disclosure.

FIG. 28 is a flowchart of a second embodiment of a balance stability checking method according to the present disclosure.

FIG. 29 is a flowchart of a first embodiment of a connection stability checking method according to the present disclosure.

FIG. 30 is a flowchart of a second embodiment of a connection stability checking method according to the present disclosure.

FIG. 31 is a flowchart of a third embodiment of a connection stability checking method according to the present disclosure.

FIG. 32 is a flowchart of a third embodiment of a balance stability checking method according to the present disclosure.

FIG. 33 is a flowchart of a fourth embodiment of a connection stability checking method according to the present disclosure.

### MODES FOR CARRYING OUT THE INVENTION

Embodiments described in the present disclosure have been made to clearly explain the concept of the present disclosure to those having ordinary skill in the art, and thus the present disclosure is not limited to the embodiments described in the present disclosure. The scope of the present disclosure should be interpreted as including variations and modifications within the concept of the present disclosure.

The terms used in the present disclosure are selected from general terms, which are currently widely used, on the basis of functions in the present disclosure, and may vary according to the intentions of those of ordinary skill in the art, the custom in the field of art, or the advance of new technology. When a specific term is defined and used with an arbitrary meaning, the meaning of the term will be described separately. Accordingly, the terms used in the present disclosure should be interpreted on the basis of the real meanings of the terms and the entire description of the present disclosure, rather than the simple names of such terms.

The accompanying drawings in the present disclosure are to facilitate the explanation of the present disclosure. The shape illustrated in the drawings may be exaggerated for the purpose of convenience of explanation, so the present disclosure is not limited to the drawings.

In the present disclosure, a detailed description of related known functions or configurations incorporated herein will be omitted as necessary when it may make the subject matter of the disclosure rather unclear.

The present disclosure discloses a device, a method, and a computer program product for providing various information that is useful for making an assembling toy by virtually connecting an assembling element, or assembling an assembling toy in an actual space.

The above features described in the present disclosure may be carried out in a virtual space in which an assembling toy or an assembling element is virtually implemented. For example, the present disclosure may provide a virtual space in which a user can dispose virtual assembling elements obtained through replication of actual assembling elements or make an assembling toy having a desired design beforehand by connecting the virtual assembling elements.

Further, the present disclosure may provide: a feature of rendering an assembling toy made in a virtual space to have an actual shape, so as to enable a user to check beforehand the figure of the assembling toy assembled in an actual space; a feature of checking, in a virtual space, stability of an assembling toy or assembling elements constituting the same so as to enable a user to check beforehand whether the balance of the assembling toy made in a virtual space is actually right, or whether the strength of each portion is sufficient; or a feature of generating an instruction for assembling an assembling toy made in a virtual space in an actual space.

Hereinafter, terms used in the present disclosure will be defined.

As described above, “virtual space” may mean a space in which an action, performed in an actual space, of making an assembling toy or connecting assembling elements can be performed virtually. Such a virtual space may be implemented through a computer or similar equipment, and may be presented to a user as an image through a visual interface such as a display.

An assembling element may be located in the virtual space. In addition, assembling elements located in the virtual space may be connected to each other in the virtual space. By using the above-described virtual space, a user may assemble beforehand an assembling toy having a desired design while reducing trial and error or difficulty that occurs when assembling elements are handled directly in an actual space.

The virtual space may be provided as a three-dimensional space and have three-dimensional coordinates accordingly. Therefore, in the virtual space, an assembling element may be disposed at a particular location indicated by three-dimensional coordinates. Accordingly, location data of the assembling element indicating a location of the assembling element in the virtual space may be provided. Further, the assembling element may have a particular posture in the virtual space. Accordingly, posture data of the assembling element indicating the posture of the assembling element in the virtual space may be provided.

In addition, in the virtual space, a virtual ground may be provided. Assembling elements can be disposed on the virtual ground. In addition, the virtual ground may be a criterion for determining the balance of an assembling toy described later.

Hereinafter, the term “assembling toy” is used for both a physical assembling toy existing in an actual space and a virtual assembling toy existing in the virtual space. However, hereinafter, in order to distinguish between the two terms, “an assembling toy existing in a virtual space” is referred to as “an assembling toy”, and “an assembling toy existing in an actual space” is referred to as “a physical assembling toy”, except for the case where the terms are clearly distinguished from each other in context. Similarly, in order to distinguish between an assembling element in a virtual space and an assembling element in an actual space, “an assembling element existing in a virtual space” is referred to as “an assembling element”, and “an assembling element existing in an actual space” is referred to as “a physical assembling element”, except for the case where the terms are clearly distinguished from each other in context.

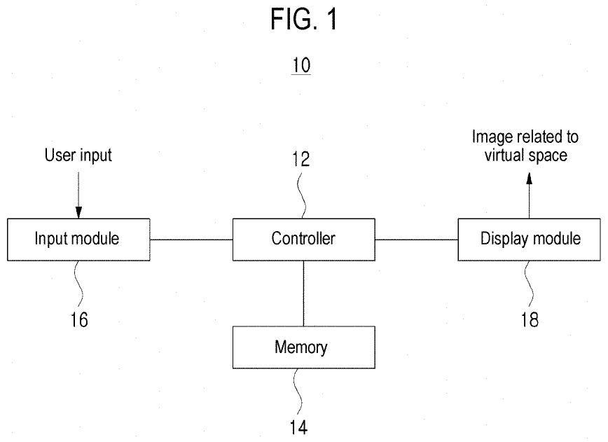

FIG. 1 is a diagram relating to a system 10 that processes a virtual space according to an embodiment of the present disclosure.

Referring to FIG. 1, the system 10 may include a controller 12, a memory 14, an input module 16, and a display module 18.

The controller 12 may perform processing and calculation of various information and control other elements included in the system 10. The controller 12 may be physically provided as a type of an electronic circuit configured to process electrical signals. The system 10 may physically include only a single controller 12, but may include a plurality of controllers 12. For example, the controller 12 may be one or a plurality of processors mounted in a personal computer. As another example, the controller 12 may be provided as processors which are mounted in a server and a terminal physically spaced apart from each other and cooperate with each other through communication.

The controller 12 may perform various steps and operations for stability determination relating to the balance of an assembling toy 1000 or the connection power of an assembling element 120, and generation of an instruction, which are described below, as well as implementation of a virtual space, and disposition or connection of assembling elements 120 in a virtual space, which are described above. In addition, an operation of receiving a user input through the input module 16, an operation of outputting an image through the display module 18, and an operation of storing various data in the memory 14 or obtaining various data from the memory 14 may be performed under the control of the controller 12. Hereinafter, various operations or steps disclosed through an embodiment of the present disclosure may be interpreted to be performed by the controller 12 unless stated separately.

The input module 16 may receive a user input from a user. The display module 18 may provide visual information to the user. For example, the display module 18 may display a virtual space, display assembling elements 120 and an assembling toy 1000 disposed in the virtual space, or display various GUIs for processing assembling elements 120 in the virtual space. The input module 16 may be provided as various types, for example, a mouse, a keyboard, and a digitizer, and should be interpreted as a concept encompassing any type of devices capable of receiving an input from a user. The display module 18 may be provided as various types, for example, a monitor, a TV, and an HMD, and should be interpreted as a concept encompassing any type of devices capable of providing visual information to a user.

Various information may be provided in the memory 14. For example, location data indicating the coordinate of an assembling element 120 disposed in a virtual space, or posture data indicating the posture of an assembling element 120 disposed in a virtual space may be stored in the memory 14. As another example, information indicating the coupling power of a coupling part 110, used for determining stability described below may be stored in the memory 14. Pieces of information stored in the memory 14 may be used to allow the controller 12 to perform various operations. In the present disclosure, the memory 14 may be interpreted as a comprehensive concept including both a volatile memory such as RAM and a nonvolatile memory such as a hard disk or flash disk.

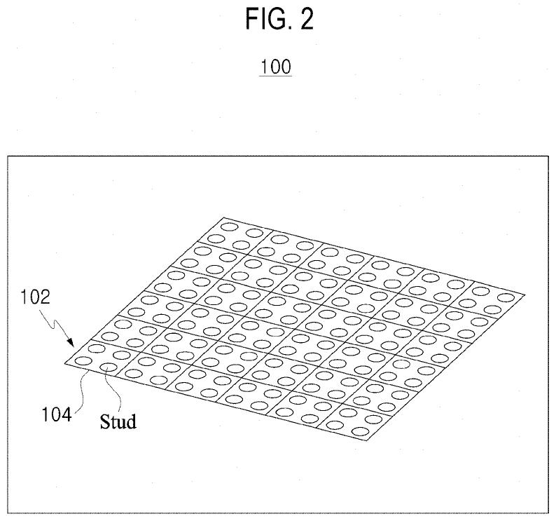

FIG. 2 is a diagram illustrating a virtual space 100 according to an embodiment of the present disclosure.

Referring to FIG. 2, the virtual space 100 may be provided as a three-dimensional space. The virtual space 100 may include a ground 102. The ground may serve as a floor on which an assembling element 120 may be disposed. However, the ground 102 is not necessarily required to be included in the virtual space 100.

FIG. 2 illustrates the ground 102 in which a cell 104 having studs arranged in 2×2 format is arranged in two dimensions, but the shape of the ground 102 is not limited to the shape illustrated in FIG. 2.

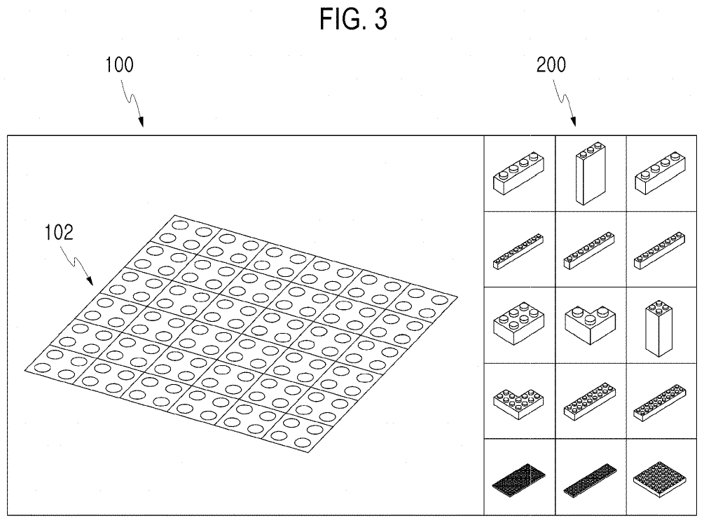

FIG. 3 is a diagram illustrating an assembling element palette 200 according to an embodiment of the present disclosure.

The system 10 may provide, together with the virtual space 100, the assembling element palette 200 as a GUI for selecting an assembling element to be disposed in the virtual space. The assembling element palette 200 may include types and shapes of assembling elements 120. The system 10 may receive an input selecting an assembling element 120 from a user through the input module 16, to determine an assembling element 120 to be disposed in the virtual space.

In addition, assembling elements 120 displayed on the assembling element palette 200 may be determined according to categories classifying the assembling elements 120. The system 10 may receive an input selecting a category of an assembling element 120 from a user, to determine the type of an assembling element 120 to be displayed on the assembling element palette 200.

In addition, the system 10 may process various operations for an assembling element 120 in the virtual space 100.

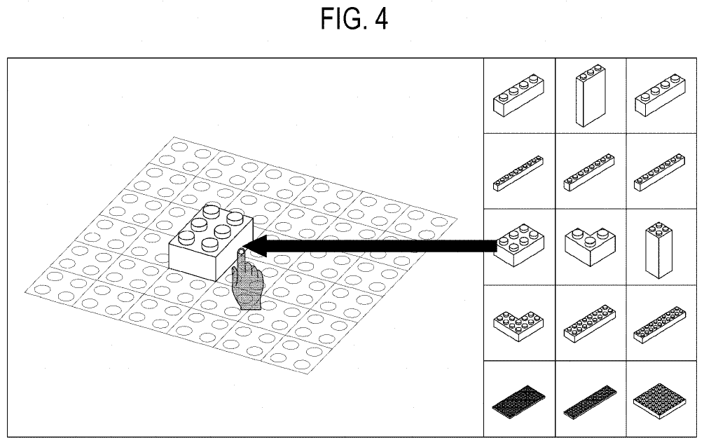

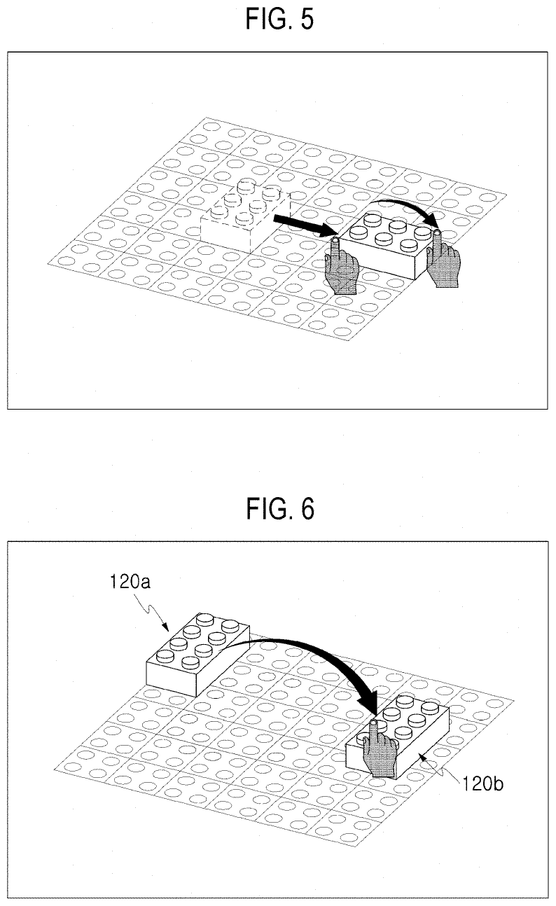

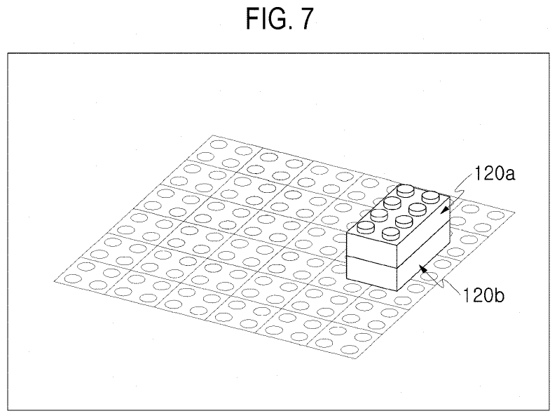

FIG. 4 is a diagram that illustrates disposing an assembling element 120 in a virtual space according to an embodiment of the present disclosure. FIG. 5 is a diagram that illustrates moving an assembling element 120 or adjusting the posture of the assembling element 120 in a virtual space according to an embodiment of the present disclosure. FIGS. 6 and 7 are diagrams that illustrate connecting an assembling element 120 in a virtual space according to an embodiment of the present disclosure.

Referring to FIG. 4, an assembling element 120 may be disposed in a virtual space. The system 10 may dispose a selected assembling element 120 at a particular location in the virtual space according to a user input. For example, the system 10 may receive a user input selecting a particular location in the virtual space and dispose an assembling element 120 at the location. As illustrated in FIG. 4, disposing of an assembling element 120 in the virtual space may be performed according to a user input of dragging and dropping, from an assembling element palette, the assembling element 120 at a location at which the assembling element 120 is to be disposed in the virtual space.

Referring to FIG. 5, the location or the posture of an assembling element 120 disposed in a virtual space may be adjusted. The system 10 may move an assembling element 120 predisposed in the virtual space, to another location in the virtual space according to a user input. For example, the system 10 may receive a user input selecting an assembling element 120 disposed in the virtual space, and according to a user input indicating a movement location of the selected assembling element 120, the system may change the location of the assembling element 120 in the virtual space. As another example, the system 10 may receive a user input selecting an assembling element 120 disposed in the virtual space, and according to a user input indicating a posture of the selected assembling element 120, the system may change the posture of the assembling element 120 in the virtual space.

Referring to FIGS. 6 and 7, assembling elements 120 may be connected to each other in a virtual space. The system 10 may connect an assembling element 120 disposed in the virtual space and another assembling element 120 disposed in the virtual space according to a user input. For example, the system 10 may receive a user input selecting an assembling element 120 disposed in the virtual space, and according to a user input indicating a connection between the selected assembling element 120 and another assembling element 120, the system may connect the assembling elements 120 in the virtual space. In a more detailed example, as illustrated in FIG. 6, when a drag-and-drop type of user input that moves a first assembling element 120a in the virtual space to a location at which the first assembling element is connected to a second assembling element 120b is received, the system 10 may connect the second assembling element 120b and the first assembling element 120a as illustrated in FIG. 7.

Hereinafter, an assembling toy 1000 and an assembling element 120 will be described.

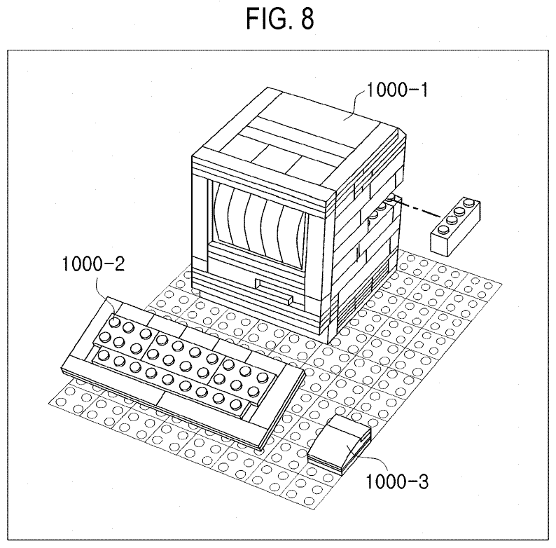

FIG. 8 is a diagram relating to an assembling element and an assembling toy according to an embodiment of the present disclosure.

In an actual space, physical assembling elements 120 may be connected to each other to complete a physical assembling toy 1000. An assembling element 120 may be provided to replicate, in a virtual space, the behavior of a physical assembling element 120 in an actual space, and assembling elements 120 may be connected to each other in the virtual space to be assembled to an assembling toy 1000 accordingly. The assembling toy 1000 described above may mean the entirety of an assembly including all the connected assembling elements 120. Therefore, if assembling elements 120 existing in a virtual space are not connected to each other, each of the assembling elements 120 configures different assembling toys 1000. That is, in a virtual space, a plurality of assembling toys 1000 may exist. Assembling elements connected through a ground or a plate may be determined to be disconnected from each other, or may be determined to be connected to each other. For example, as illustrated in FIG. 8, if the assembling elements 120 are assembled in a personal computer type, a first assembling toy 1000-1 having a PC shape, a second assembling toy 1000-2 having a keyboard shape, and a third assembling toy 1000-3 having a mouse shape may be determined to exist in a virtual space. As another example, all the assembling elements 120 illustrated in FIG. 8 may be determined to form a single assembling toy 1000. In FIG. 8, if the assembling elements 120 are assumed to be disposed on a plate-like assembling element 120 rather than a virtual ground, all the assembling elements 120 may be connected to each other through the plate-like assembling element 120, and thus may be determined to be a single assembling toy 1000. In FIG. 8, if the assembling elements 120 are assumed to be disposed on a plate-like assembling element 120 rather than a virtual ground, a connection by plate-like assembling elements 120 is determined not to correspond to a connection between assembling elements 120, which is considered as a classification of an assembling toy 1000, and thus a plurality of assembling toys 1000 may be determined to be in a virtual space.

Hereinafter, an assembling element 120 will be described in more detail.

An assembling element 120 may mean a unit constituting an assembling toy 1000. An assembling element 120 may be connected to another assembling element 120. In addition, an assembling element 120 may be provided in various types.

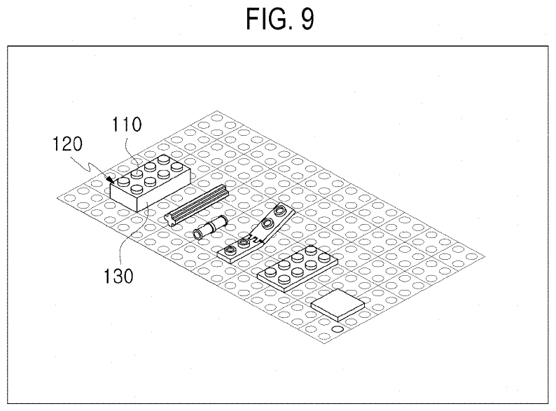

FIG. 9 is a diagram illustrating various types of assembling elements according to an embodiment of the present disclosure.

Referring to FIG. 9, an assembling element 120 may have various types. The types of the assembling element 120 may include, for example, a brick type having a hexahedral shape, an axle type extending lengthwise with a cross section having a shape of a cross, a pin connector type including a pin, a hinge type in which two plates are connected by a hinge structure and the angle therebetween is adjusted, a plate type having a flat shape and a stud, and a tile type having a flat shape and lacking a stud. Further, the types of the assembling element 120 may include many other types in addition to the above mentioned examples according to the entire shape, size, and the type of a coupling part 110.

Each of assembling elements 120 may include a body 130 and a coupling part 110. A body 130 corresponds to a part forming the exterior of an assembling element 120, and a coupling part 110 corresponds to a portion functioning to connect the assembling element 120 to another assembling element 120. For example, a brick type assembling element 120 illustrated in FIG. 9 has a hexahedral body 130 and eight studs as a coupling part 110 formed on the body 130. A coupling part 110 of an assembling element 120 is a term defined functionally, and thus is not always required to be physically distinguished from the body 130. For example, a coupling part 110 may be integrally formed with a body 130 like a coupling part 110 of an axle type assembling element 120 illustrated in FIG. 9.

A coupling part 110 may be coupled to another coupling part 110. Assembling elements 120 may be connected to each other through the coupling of the coupling parts 110. A connection of assembling elements 120 may mean that coupling part 110 of the assembling elements 120 are coupled to each other, whereby the two assembling elements 120 are fixed to each other. Therefore, two assembling elements 120 simply being in contact with each other without the coupling between coupling parts 110 may be considered to be disconnected from each other.

For example, a coupling part 110 may be coupled to another coupling part 110 having a shape complementary to the coupling part.

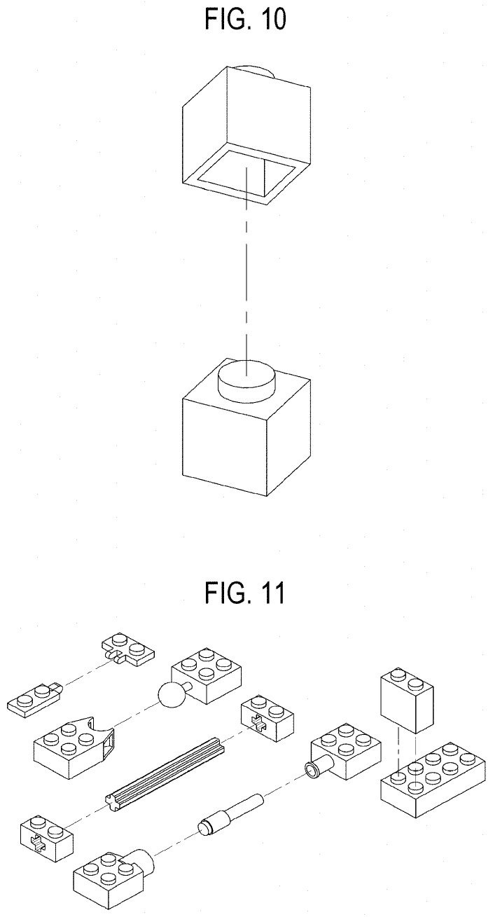

FIGS. 10 and 11 are diagrams illustrating examples of coupling of coupling parts according to an embodiment of the present disclosure. For example, as illustrated in FIG. 10, a stud type coupling part 110 is inserted by press-fitting to a cavity type coupling part 110, whereby the two coupling parts 110 may be coupled to each other. That is, in FIG. 10, the two coupling parts 110 may be coupled by a male-female connection between a stud and a cavity.

Further, a coupling part 110 may be various shapes in addition to the shapes illustrated in FIG. 10.

For example, a coupling part 110 may be provided with a stud or cavity having the number and/or arrangement different from those of the 1×1 stud and the 1×1 cavity illustrated in FIG. 10. For example, a coupling part 110 may be provided with 2×2 studs, 1×4 studs, or three studs bent perpendicularly, or cavities complementary to the above studs. That is, a stud type coupling part 110 may have various shapes of grid patterns, and a cavity may also have various shapes complementary to the above stud type coupling part. As another example, a coupling part 110 may be provided as a type of an axle or a groove to which an axle is inserted. There may be a wide variety of other types of coupling parts 110 as well as the examples illustrated in FIG. 11, and the disclosure is not limited to the examples.

Hereinafter, an operation of checking the stability of an assembling toy 1000 according to an embodiment of the present disclosure will be described. As noted from the following description, a stability checking operation can be performed by the above described system.

Checking the stability of an assembling toy is to provide guide information relating to whether an assembling toy 1000 assembled in a virtual space can also be stable in an actual space. A target of stability checking may include both an assembling toy 1000 in a process of assembling and a finished product completed according to a final design.

According to an example, the system 10 may check whether an assembling toy 1000 in a virtual space can be stably supported on a ground. In other words, the system 10 may provide information relating to whether an assembling toy 1000 in a virtual space is balanced.

According to another example, the system 10 may check whether each portion of an assembling toy 1000 in a virtual space can stably maintain the assembled state. In other words, the system 10 may provide information relating to whether the connection between assembling elements 120 included in an assembling toy 1000 in a virtual space is stable, or whether the coupling by coupling parts 110 forming the connection between the assembling elements 120 is stable.

For the above described checking of the stability of an assembling toy 1000, weight information of assembling elements 120 in a virtual space, information relating to a contact surface with a ground, and coupling power information between coupling parts 110 may be used.

Hereinafter, pieces of information used for checking the stability of an assembling toy 1000 will be described before the stability checking is described.

First, weight information may be assigned to an assembling element 120. A weight assigned to an assembling element 120 may be information reflecting the weight of an actual physical assembling element 120. Such weight information may be stored in the memory.

For example, weight information assigned to an assembling element 120 may be determined by the volume and density of the assembling element 120. The weight values of several basic type assembling elements 120 are stored in the memory, and on the basis of the stored values, the controller may calculate the weight value of an assembling element 120, the type of which is derived from an assembling element 120, the weight value of which is stored. For example, the weight value of a brick type assembling element 120 having a 1×1 stud may be stored in the memory as “1”. The controller may calculate the weight value of a brick type assembling element 120 having 1×2 studs by multiplying the weight value of the brick type assembling element 120 having the 1×1 stud by 2 which is a ratio in volume between the two assembling elements.

As another example, the weight values of assembling elements 120 may be individually stored in the memory.

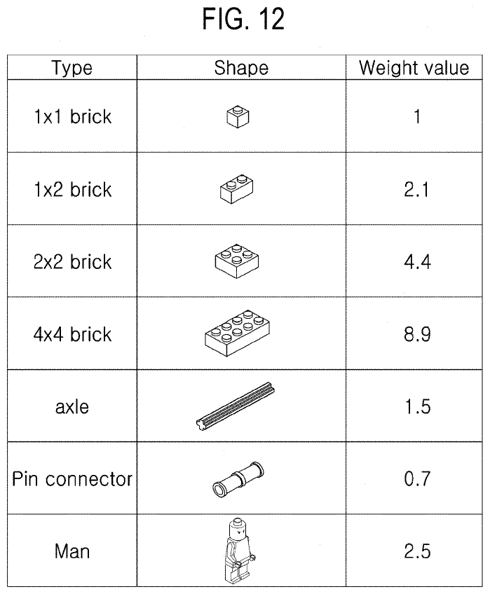

FIG. 12 is a diagram relating to the weight values of assembling elements according to an embodiment of the present disclosure. Referring to FIG. 12, the weight values of assembling elements 120 may be provided in a lookup table type.

The value of weight information assigned to a virtual assembling element 120 is not necessarily required to be identical or proportional to the weight of a physical assembling element 120, and the value of the weight information may even be approximated for convenience of weight calculation in a virtual space.

Next, coupling power information between coupling parts 110 of assembling elements 120 may be configured. Coupling power information between coupling parts 110 may reflect the power of coupling between coupling parts 110 of actual physical assembling elements 120. Such coupling power information may be stored in the memory.

For example, coupling power information between coupling parts 110 may be determined by the types and number of the coupling parts 110. The coupling powers of several basic type coupling parts 110 are stored in the memory, and on the basis of the stored values, the controller may calculate the coupling power between various shapes of the coupling parts 110. For example, the coupling power between a 1×1 stud and a 1×1 cavity may be stored in the memory as “1”. The controller may calculate the coupling power between 1×2 studs and 1×2 cavities by multiplying the coupling power value between the 1×1 stud and the 1×1 cavity, by 2 which is a ratio of the number of pairs of studs and cavities that are coupled to each other.

As another example, coupling power values between coupling parts 110 may be individually stored in the memory.

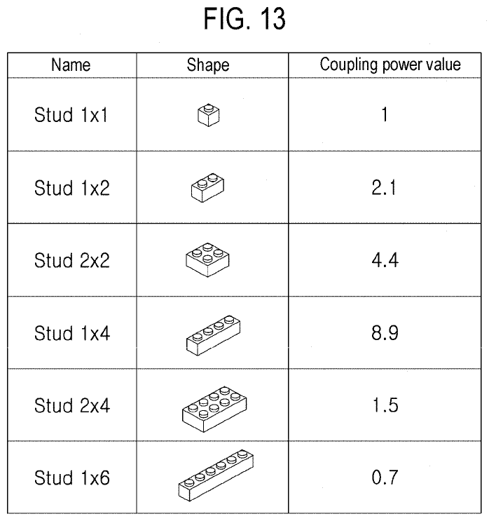

FIGS. 13 and 14 are diagrams relating to coupling power values between coupling parts 110 according to an embodiment of the present disclosure. Referring to FIGS. 13 and 14, coupling power values may be provided in a lookup table type.

A coupling power value between coupling parts 110 connecting virtual assembling elements 120 is not necessarily required to be identical or proportional to a physical coupling power value, and may even be approximated for convenience of coupling power calculation in a virtual space.

In FIGS. 13 and 14, the coupling power between coupling parts 110 is illustrated to be determined by one of two coupling powers included in the coupling between the coupling parts 110. However, the coupling power between coupling parts 110 may not necessarily be determined by one coupling part 110. For example, the power of the coupling in which a 1×1 stud is involved may be different according to the shape of a cavity coupled to the 1×1 stud, and thus the coupling power between coupling parts 110 may be determined in consideration of both sides of the two coupling parts 110 involved in the coupling.

In addition, in the above, calculation of the coupling power between the coupling parts 110 is described as fixedly determined by the type and number of the coupling parts 110, but the calculation is not necessarily determined in such a manner.

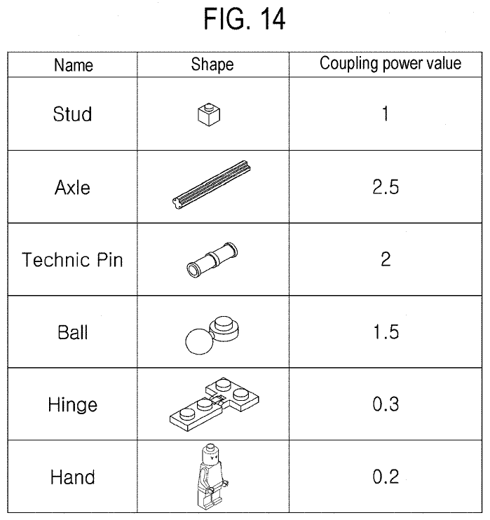

FIG. 15 is a diagram illustrating an example of a coupled state between coupling parts according to an embodiment of the present disclosure. Referring to FIG. 15, the assembling element 120 in an inserted coupling part 110 (male coupling part) side has a 2×3 stud type coupling part 110, and the assembling element 120 in a receiving coupling part 110 (female coupling part) side has a 2×2 stud type coupling part 110. However, the type of the coupling between the coupling parts 110 corresponds to a 1×2 stud type. Therefore, the coupling power between the two coupling parts 110 illustrated in FIG. 15 may be determined as the coupling power of the 1×2 stud type. In other words, to be more precisely, the coupling power between coupling parts 110 is determined by a coupling type rather than the coupling parts 110 involved in the coupling. As apparent from the following description, the coupling between coupling parts 110 may be expressed to be the coupling of coupling parts 110 in the case where the term is clear in the context, for convenience of explanation in the present disclosure.

Therefore, the coupling power between coupling parts 110 may be stored in the memory according to types in which the coupling parts 110 may be coupled to each other, or the controller may calculate a coupling power value relating to a derived type on the basis of a coupling power value (e.g. a coupling power value of a 1×1 stud) of a basic coupling type stored in the memory.

Hereinafter, a method for checking balance of an assembling toy 1000 will be described as an example of a stability checking method according to an embodiment of the present disclosure. The method according to the present embodiment may be implemented by the above-described system 10 or a device for implementing the above-described system, and may be implemented by a computer program product that can be executed by the system or the device.

Balance stability of an assembling toy 1000 may mean whether the assembling toy 1000 constituted by an assembling element 120 can maintain the standing state on a ground without collapsing.

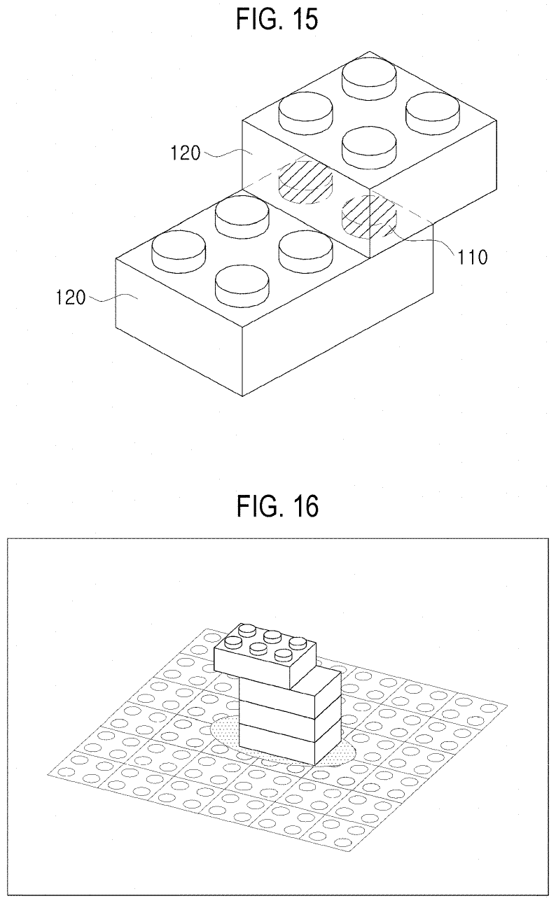

FIGS. 16 and 17 are diagrams relating to a determination of the balance stability of an assembling toy according to an embodiment of the present disclosure.

Balance stability may be determined on the basis of weight information of assembling elements 120 constituting an assembling toy 1000. More specifically, balance stability of the assembling toy 1000 may be determined on the basis of a position relationship between a mass center of assembling elements 120 constituting the assembling toy 1000, and a lowest surface of the assembling toy 1000, which is a surface contacting a ground.

The mass center of an assembling toy 1000 may be calculated on the basis of weight information of assembling elements 120 constituting the assembling toy 1000 and location data of the assembling elements 120. The controller may obtain respective weight values of assembling elements 120 constituting the assembling toy 1000 on the basis of weight information of the assembling elements 120 stored in the memory. The controller may obtain location data of assembling elements 120 in a virtual space. The controller may obtain the location of a mass center of the assembling toy 1000 on the basis of the weight values and location data of assembling elements 120. The location may be obtained as two-dimensional information excluding a height direction.

Referring to FIG. 16, four brick type assembling elements 120 constituting an assembling toy 1000 have a mass center positioned in a bottom surface of the assembling toy 1000, and thus the assembling toy 1000 may be determined to have balance stability. Referring to FIG. 17, four brick type assembling elements 120 constituting an assembling toy 1000 have a mass center positioned out of a bottom surface of the assembling toy 1000, and thus the assembling toy 1000 may be determined not to have balance stability.

The controller may display a region indicator indicating a bottom surface with respect to whether an assembling toy 1000 has balance stability, and provide a user with intuitive visual information about whether the assembling toy 1000 has balance stability, through a color of the region indicator.

In a case where an assembling toy 1000 may have a plurality of bottom surfaces, the location of the mass center of the assembling toy 1000 may be positioned outside the bottom surfaces of the assembling toy 1000. However, if the location is positioned in a support surface formed by the bottom surfaces of the assembling toy 1000, the assembling toy may be determined to have balance stability.

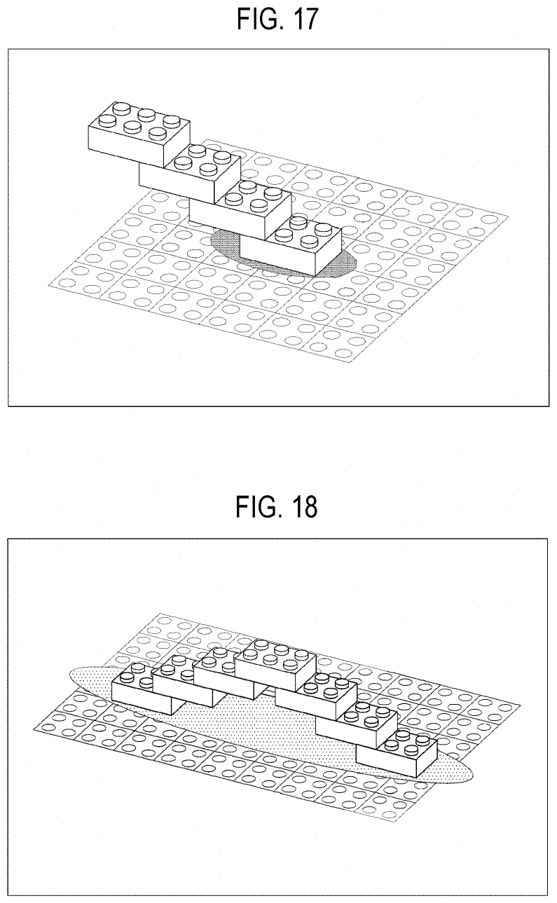

FIG. 18 is another diagram relating to a determination of balance stability of an assembling toy according to an embodiment of the present disclosure. Referring to FIG. 18, if an assembling toy 1000 has a plurality of bottom surfaces spaced from each other, a support surface including a region positioned between a bottom surface and a bottom surface may be set instead of the plurality of bottom surfaces. That is, the controller may set a support surface on the basis of the positions of the plurality of bottom surfaces. Balance stability may be set on the basis of whether a mass center is located in a support surface.

If a part of assembling elements 120 constituting an assembling toy 1000 is an element capable of changing its posture by a hinge structure, location data may be calculated in further consideration of posture information of a corresponding assembling element 120 when a mass center is calculated, or a mass center may be calculated in this manner.

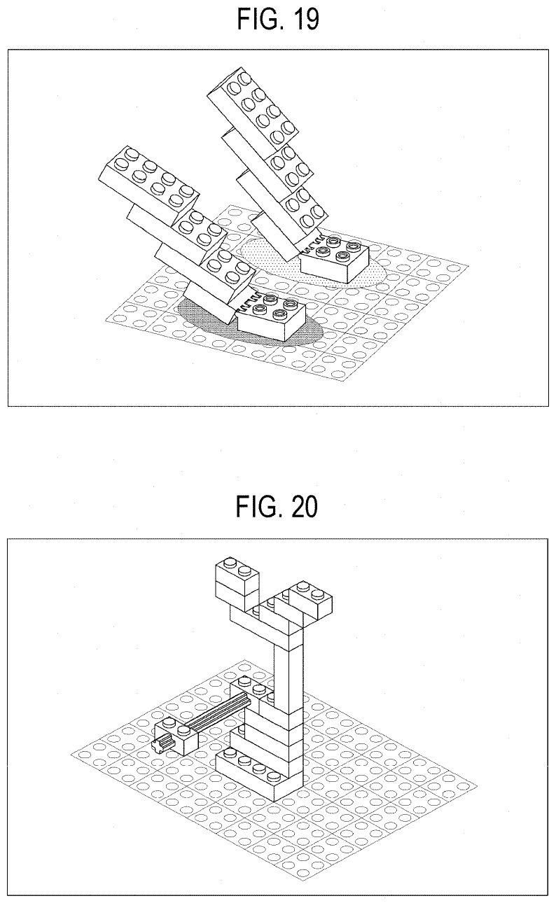

FIG. 19 is yet another diagram relating to a determination of balance stability of an assembling toy according to an embodiment of the present disclosure. Referring to FIG. 19, if an assembling element 120 of an assembling toy 1000 is a hinge type in which an angle is adjusted from a first posture to a second posture, a mass center may be calculated in additional consideration of the angle of the hinge, or posture information of assembling elements 120, the postures of which are changed by the hinge.

In the above description, balance stability is determined simply on the basis of whether a mass center of an assembling toy 1000 is located in a bottom surface or a support surface of the assembling toy 1000. However, information indicating balance stability through a plurality of stages may be provided in consideration of how far off the mass center is from the center of a support surface and/or a bottom surface, or how close the mass center is to the edge of a support surface and/or a bottom surface.

Hereinafter, a method for checking coupling stability of an assembling toy 1000 will be described as another example of a stability checking method according to an embodiment of the present disclosure. The method according to the present embodiment may be implemented by the above-described system 10 or a device for implementing the above-described system, and may be implemented by a computer program product that can be executed by the system or the device.

Connection stability of an assembling toy 1000 may mean whether the connection between assembling elements 120 constituting the assembling toy 1000 can stably maintain the connection state.

Connection stability of an assembling toy 1000 located in a virtual space may be determined on the basis of coupling power information of an assembling element 120 used for assembling the toy. More specifically, connection stability may be determined on the basis of the coupling power between coupling parts 110 connecting assembling elements 120 constituting an assembling toy 1000 and information relating to a weight applied to a corresponding coupling part 110.

First, the system 10 may scan a coupling point of an assembling toy 1000 in a virtual space. A coupling portion may mean a portion at which coupling parts 110 of two connected assembling elements 120 are coupled to each other.

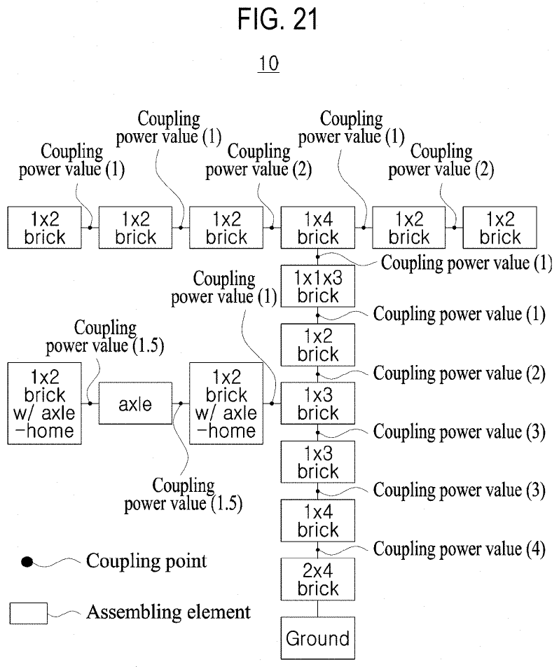

FIGS. 20 and 21 are diagrams illustrating a coupling point according to an embodiment of the present disclosure.

Referring to FIGS. 20 and 21, the system 10 may scan a point between assembling elements 120, at which coupling parts 110 are coupled to each other. The controller may scan, on the basis of location data of assembling elements 120 disposed in a virtual space, a coupling point at which coupling parts 110 thereof are connected to each other. For example, as illustrated in FIG. 20, in a case where a total of fifteen assembling elements 120 form an assembling toy 1000 in a virtual space, each coupling point may be positioned at coupling parts 110 coupled to each other.

If a coupling portion is scanned, then coupling power may be calculated for each coupling portion. The coupling power may be calculated based on coupling power for each coupling type stored in the memory. For example, as illustrated in FIG. 21, the coupling power of single stud coupling may be set as 1, and the coupling power of double stud coupling may be set as 2. In addition, the power of coupling between an axle and an axle hole may be calculated to be 1.5. A power value for each coupling type merely corresponds to an example.

The system may set an assembling element group 300 for determination of connection stability on the basis of coupling power. Specifically, an assembling element group 300 may be set based on at least one threshold coupling power and at least one coupling power.

The system 10 may set an assembling element group 300 by comparing a coupling power with a threshold coupling power. A threshold coupling power may be variously set.

For example, a threshold coupling power may be set by inputting a preset coupling power value as the threshold coupling power. In such a case, the preset coupling power value inputted as the threshold coupling power may be variously changed. For example, if a threshold coupling power is defined as 2, building elements 120 connected with two or more coupling powers may be set as a single assembling element group 300.

In another example, a threshold coupling power may be set in consideration of a weight of a building element 120. In such a case, the system 10 may set a threshold coupling power on the basis of the coupling power of an inspection coupling point and the weight of an assembling element 120, an assembling element group 300, or an assembling toy 1000, which is positioned at one side of the inspection coupling point, or the weight of an assembling element 120, or an assembling element group 300 or an assembling toy 1000, which is positioned at both sides of the inspection coupling point. In such a case, the threshold coupling power may be changed according to the magnitude of weight. For example, the greater the weight of an assembling element group 300 positioned at one side, the more the magnitude of the threshold coupling power can increase.

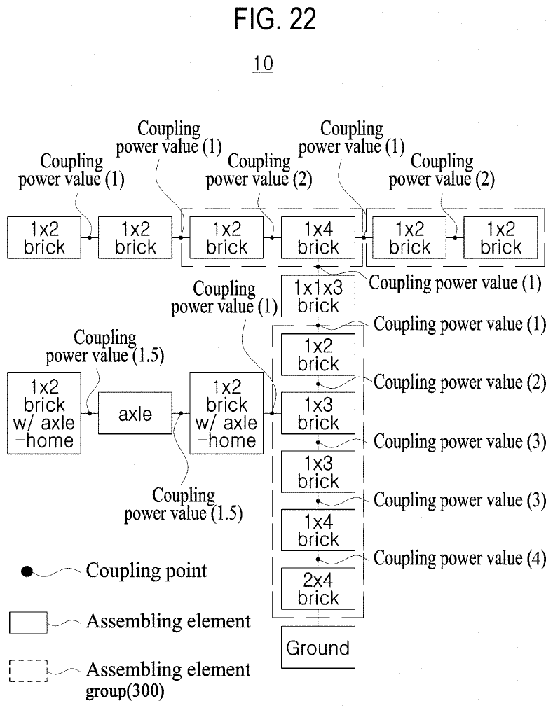

FIGS. 22 to 24 are diagrams illustrating grouping of assembling elements according to an embodiment of the present disclosure.

Referring to FIG. 22, an assembling element group 300 may be generated by grouping of assembling elements 120 connected with two or more (e.g. two studs or more) of coupling powers. It is also possible to set an assembling element group 300 with respect to a plurality of threshold values when assembling elements 120 are grouped.

Referring to FIGS. 23 and 24, an assembling element group 300 may be set based on power 1 and power 3.

If an assembling element group 300 is set, a coupling point between an assembling element 120 belonging to the assembling element group 300 and an assembling element 120 not belonging to the assembling element group 300 may be scanned as an inspection coupling point for determining coupling stability.

The system 10 may determine connection stability on the basis of the coupling power of an inspection coupling point. Further, the system 10 may determine connection stability on the basis of the weight of an assembling element 120, an assembling element group 300, or an assembling toy 1000, which is positioned at one side of an inspection coupling point, or the weight of an assembling element 120, an assembling element group 300, or an assembling toy 1000, which is positioned at both sides of the inspection coupling point.

The weight of an assembling element 120 described above may mean the weight of an assembling element 120 positioned at one side of an inspection coupling point, the weight of an assembling element 120 positioned at both sides thereof, or the weight of an assembling element 120 positioned at the other side thereof.

In addition, the weight of an assembling element group 300 described above may mean the weight of an assembling element group 300 positioned at one side of an inspection coupling point, the weight of an assembling element group 300 positioned at both sides thereof, or the weight of an assembling element group 300 positioned at the other side thereof.

The system 10 may determine connection stability by comparing the coupling power of a building element 120 with the weight of an assembling element 120, an assembling element group 300, or an assembling toy 1000, which is positioned at one side of an inspection coupling point, or the weight of an assembling element 120, an assembling element group 300, or an assembling toy 1000, which is positioned at both sides of the inspection coupling point. For example, in the case where the weight of a building element 120 is equal to or larger than 10, if the coupling power of the building element is equal to or larger than 3, the system 10 may determine that the connection of the building element 120 is stable. Each weight and coupling power values merely correspond to examples.

As coupling power becomes stronger, connection stability may be determined to be greater. Further, connection stability may be determined to be lower as the weight of an assembling element 120 or an assembling element group 300 becomes larger.

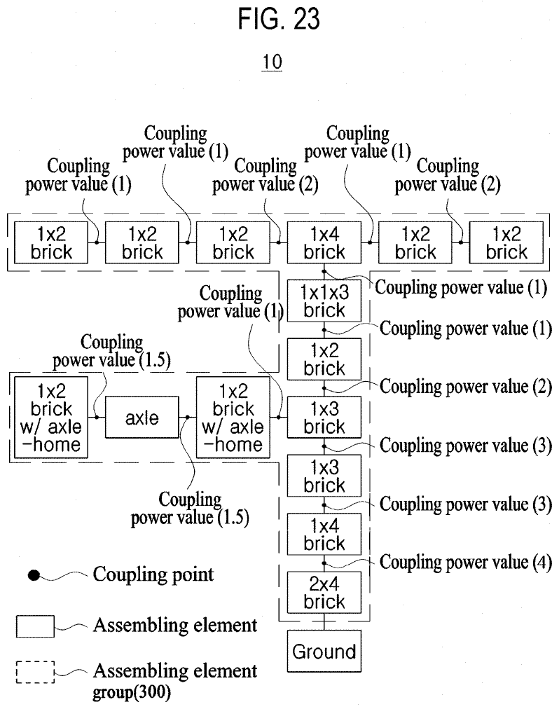

FIG. 25 is a diagram that illustrates displaying assembly stability by using visual information according to an embodiment of the present disclosure.

If assembly stability is determined, the assembly stability may be displayed by using visual information, on the basis of an assembly stability value of a corresponding coupling point. For example, as illustrated in FIG. 25, if assembly stability is sufficient, an assembling element 120 may not be separately marked. As the assembly stability becomes weaker, an assembling element 120 may be displayed with a dark color.

Hereinafter, an embodiment of a stability checking method according to the present disclosure will be described.

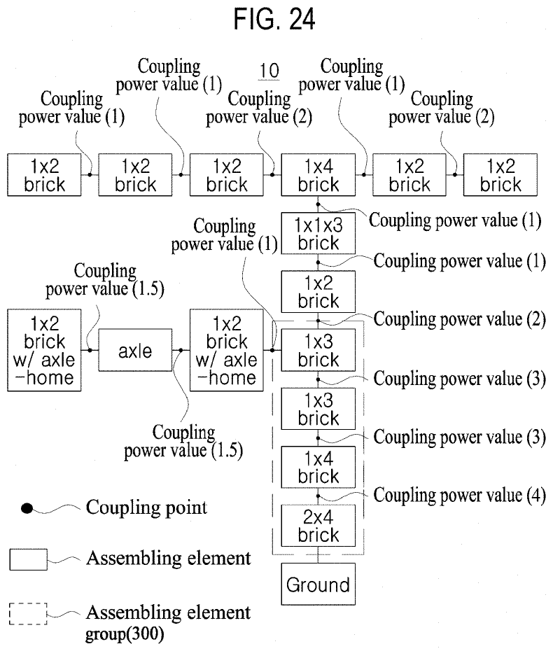

FIG. 26 is a flowchart relating to a stability checking method according to an embodiment of the present disclosure.

Referring to FIG. 26, a stability checking method may include a method for checking connection stability of an assembling element 120 and a method for checking balance stability of an assembling toy 1000. Connection stability checking and balance stability checking may be performed by various methods. That is, connection stability checking and balance stability checking are illustrated as being performed individually in FIG. 26, but may be performed in the same stage according to an algorithm.

In order to determine connection stability of an assembling element, a stability checking method may include: assigning a weight to an assembling element disposed in a virtual space (S1); calculating a coupling power of a coupling part 110 (S2); grouping a plurality of assembling elements to an assembling element group (S3); and determining connection stability of the assembling element on the basis of coupling power and weight information (S4).

In order to determine balance stability of an assembling toy 1000, a stability checking method may include: assigning a weight to an assembling element disposed in a virtual space (S1); calculating a mass distribution of an assembling toy (S5); and determining balance stability of the assembling toy on the basis of the mass distribution (S6).

A stability checking method for connection stability determination and balance stability determination may be variously provided. For example, as illustrated in FIG. 26, after assigning the weight to the assembling element disposed in the virtual space (S1), determination of connection stability of the assembling element 120 and determination of balance stability of an assembling toy 1000 may be individually performed. As another example, assigning the weight to the assembling element disposed in the virtual space (S1) may be performed after calculating the coupling power of the coupling part 110 (S2) or grouping the plurality of assembling elements to the assembling element group (S3) and may be performed in the process of determining the connection stability. Each step will be described in detail below.

Hereinafter, a first embodiment of a balance stability checking method according to the present disclosure will be described.

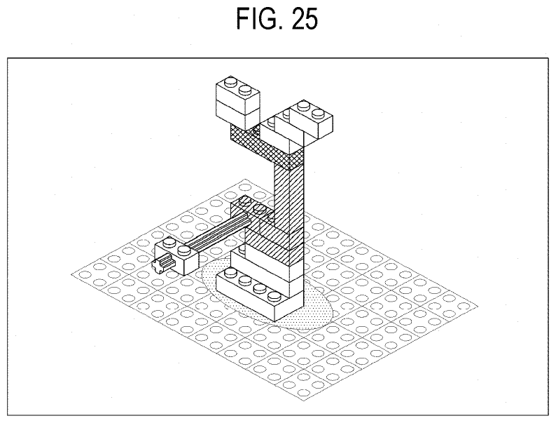

FIG. 27 is a flowchart of the first embodiment of the balance stability checking method according to the present disclosure.

As illustrated in FIG. 27, the balance stability checking method may include: assigning a weight to an assembling element disposed in a virtual space (S100); calculating a mass distribution assigned to an assembling toy (S110); and determining balance stability of the assembling toy (S120).

Assigning the weight to the assembling element disposed in the virtual space (S100) may precede calculating the mass distribution. The mass distribution may be calculated in the process of assigning the weight to the assembling element 120.

In calculating the mass distribution assigned to the assembling toy (S110), the mass distribution assigned to the assembling toy 1000 may be calculated on the basis of the weight assigned to the assembling element 120 and location data of the assembling element 120. In such a case, a mass center of the assembling toy 1000 may be calculated on the basis of weight information of assembling elements 120 constituting the assembling toy 1000 and location data of the assembling elements 120.

In determining the balance stability of the assembling toy 1000 (S120), the balance stability may be determined on the basis of the weight information of the assembling elements 120. More specifically, the balance stability of the assembling toy 1000 may be determined on the basis of a position relationship between a mass center of assembling elements 120 constituting the assembling toy 1000, and a lowest surface of the assembling toy 1000 which is a surface contacting a ground.

Hereinafter, a second embodiment of a balance stability checking method according to the present disclosure will be described.

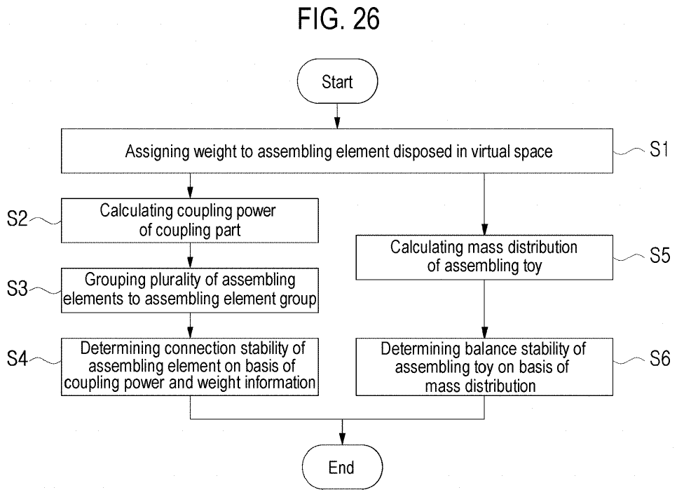

FIG. 28 is a flowchart of the second embodiment of the balance stability checking method according to the present disclosure.

Referring to FIG. 28, the balance stability checking method may include: calculating a mass distribution assigned to an assembling toy (S200); and determining whether a mass center of the assembling toy is included in a region perpendicular to a bottom surface of the assembling toy (S210). In order to determine balance stability of the assembling toy 1000, it may be determined whether a mass center of the assembling toy 1000 is included in a region perpendicular to a bottom surface of the assembling toy 1000.

In determining whether the mass center of the assembling toy is included in the region perpendicular to the bottom surface of the assembling toy (S210), balance stability may be determined according to whether a mass center of assembling elements 120 constituting the assembling toy 1000 is positioned in the bottom surface of the assembling toy 1000. Two-dimensional information excluding a height direction may be used as location data of the mass center.

In addition, if an assembling toy 1000 has a plurality of bottom surfaces, a support surface including a region between a bottom surface and another bottom surface may be set instead of the plurality of bottom surfaces.

Hereinafter, a first embodiment of a connection stability checking method according to the present disclosure will be described.

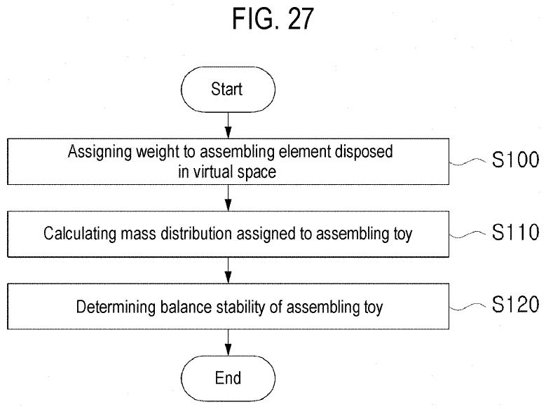

FIG. 29 is a flowchart of the first embodiment of the connection stability checking method according to the present disclosure.

Referring to FIG. 29, the connection stability checking method may include: calculating a coupling power of a coupling part 110 (S300); and determining connection stability between an assembling element and another assembling element (S310).

Calculating the coupling power of the coupling part 110 (S300) corresponds to calculating the power of coupling between coupling parts 110, and the coupling power may be calculated by various methods. For example, coupling power between variously shaped coupling parts 110 may be calculated on the basis of the coupling powers of several basic type coupling parts 110. As another example, coupling power values between coupling parts 110 may be individually stored in the memory, and on the basis of the individual coupling power values, the coupling power between coupling parts 110 may be calculated.

Determining the connection stability between the assembling element 120 and another assembling element 120 (S310) may be performed on the basis of the coupling power of the assembling element 120. More specifically, the connection stability may be determined on the basis of the coupling power between coupling parts 110 connecting assembling elements 120 constituting an assembling toy 1000 and information relating to a weight applied to a corresponding coupling part 110.

The connection stability checking method may further include assigning a weight to an assembling element 120 disposed in a virtual space.

Hereinafter, a second embodiment of a connection stability checking method according to the present disclosure will be described.

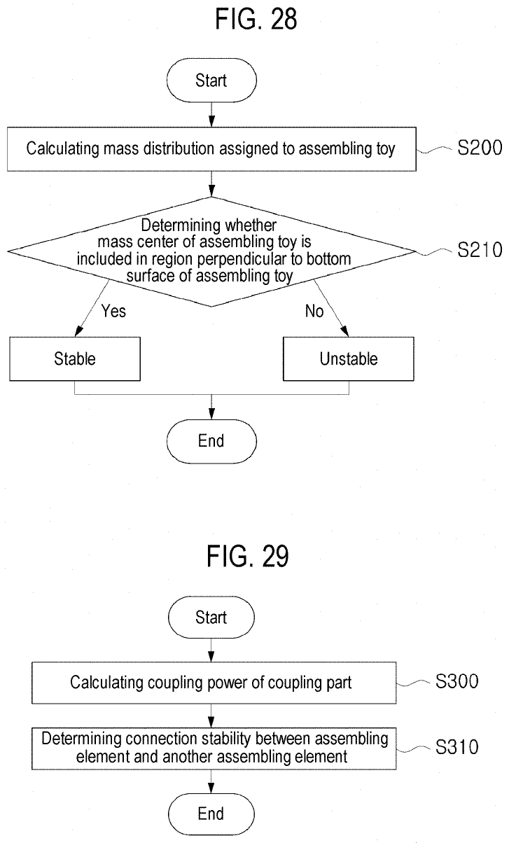

FIG. 30 is a flowchart of the second embodiment of the connection stability checking method according to the present disclosure.

Referring to FIG. 30, the connection stability checking method may include: calculating a coupling power of a coupling part 110 (S400); grouping a plurality of assembling elements to an assembling element group (S410); and determining connection stability between an assembling element and another assembling element (S420).

In grouping the plurality of assembling elements to the assembling element group (S410), a group of the assembling elements 120 for determining connection stability may be set on the basis of coupling power. Specifically, the group of the assembling elements 120 may be set based on at least one threshold coupling power and at least one coupling power.

In determining the connection stability between the assembling element and the another assembling element (S420), coupling stability may be determined on the basis of a coupling power of a coupling point to be checked and a weight of the assembling element 120. The weight of an assembling element 120 described above may mean the weight of an assembling element 120 or a group of an assembling element 120, positioned at one side of an inspection coupling point, or the weight of an assembling element 120 or a group of an assembling element 120, positioned at both sides of an inspection coupling point.

Hereinafter, a third embodiment of a connection stability checking method according to the present disclosure will be described.

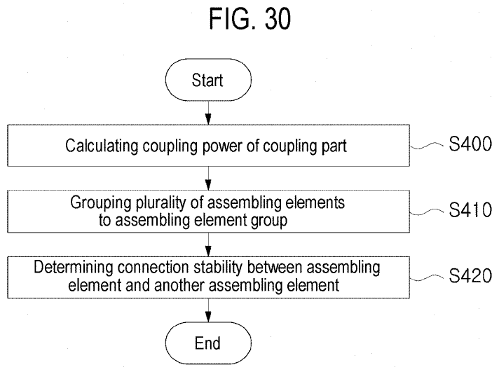

FIG. 31 is a flowchart of the third embodiment of the connection stability checking method according to the present disclosure.

Referring to FIG. 31, the connection stability checking method may include: determining connection stability (S500); comparing the connection stability with a first predetermined value (S510); and comparing the connection stability with a second predetermined value (S520).

The first predetermined value may be a value reflecting connection stability weaker than the second predetermined value.

Determining the connection stability may correspond to determining connection stability between an assembling element 120 and another assembling element 120.

Comparing the connection stability with the first predetermined value (S510) and comparing the connection stability with the second predetermined value (S520) may be provided by various methods.

For example, comparing the connection stability with the first predetermined value (S510) may include: if the stability of a determined connection assembling element 120 is smaller than the first predetermined value, determining the determined assembling element 120 to be in a warning state; and if the stability of the assembling element 120 is equal to or larger than the first predetermined value, comparing the connection stability with the second predetermined value.

Comparing the connection stability with the second predetermined value (S520) may include: if the stability of the determined assembling element 120 is smaller than the second predetermined value, determining the determined assembling element 120 to be in a caution state; and if the stability of the determined assembling element 120 is equal to or larger than the second predetermined value, determining the determined assembling element 120 to be in a stable state.

Although not illustrated, as another example, the connection stability of an assembling element 120 may be compared with the first predetermined value and the second predetermined value algorithmically at the same time. In addition, the connection stability of an assembling element 120 may be compared with the first predetermined value after being compared with the second predetermined value.

As another example, comparing connection stability with the first predetermined value and determining as a warning state if the connection stability of an assembling element 120 is equal to or smaller than the first predetermined value, and comparing the connection stability with the second predetermined value if the connection stability of the assembling element 120 exceeds the first predetermined value may be provided. If the connection stability of the determined assembling element 120 is equal to or smaller than the second predetermined value, the connection stability of the connected assembling element 120 may be determined to be in a caution state, and if the connection stability exceeds the second predetermined value, the connection stability of the connected assembling element 120 may be determined to be in a stable state.

The connection stability may be variously determined. That is, in FIG. 31, connection stability is determined as three states which are a stable state, a caution state, and a warning state. However, for example, connection stability may be discriminately determined between two states that are a stable state and an unstable state, and may be discriminately determined between four or more states.

In comparing the connection stability with a predetermined value (S510, S520), the connection stability of the connected assembling element 120 may be determined according to a range of the determined connection stability.

Hereinafter, a third embodiment of a balance stability checking method according to the present disclosure will be described.

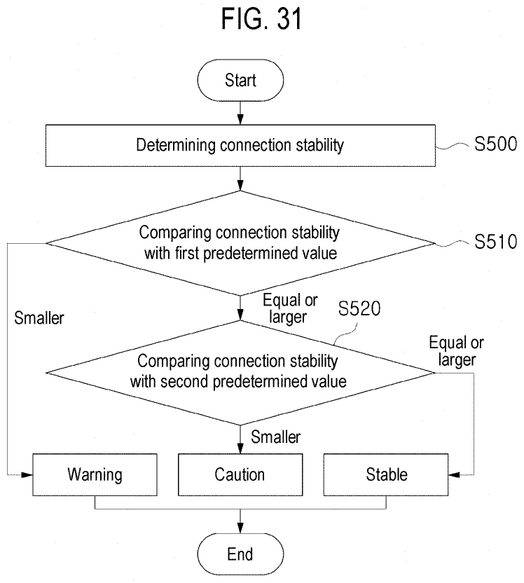

FIG. 32 is a flowchart of the third embodiment of the balance stability checking method according to the present disclosure.

Referring to FIG. 32, the balance stability checking method may include: determining balance stability of an assembling toy (S600); and displaying a color on the basis of the balance stability (S610).

Displaying the color on the basis of the balance stability (S610) may correspond to displaying a color of a flat surface including a bottom surface of an assembling toy 1000. In addition, displaying the color on the basis of the balance stability may correspond to displaying a color of an assembling element 120 constituting a bottom surface of the assembling toy 1000.

In addition, displaying the color on the basis of the balance stability (S610) may correspond to changing a color by comparing the balance stability with a predetermined value. Displayed color may be different according to balance stability. In this case, a color of a flat surface including a bottom surface may be changed according to balance stability. For example, in case of an assembling toy 1000 having high balance stability, the color of a flat surface including a bottom surface may be displayed in green. For example, in case of an assembling toy 1000 having low balance stability, the color of a flat surface including a bottom surface may be displayed in red.

Hereinafter, a fourth embodiment of a connection stability checking method according to the present disclosure will be described.

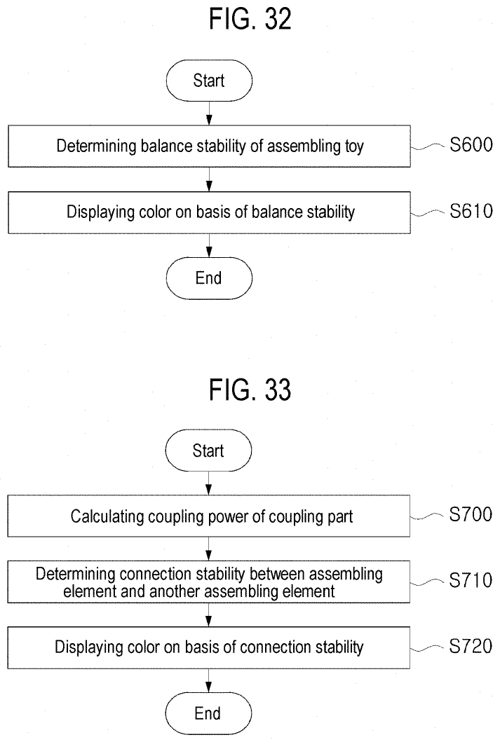

FIG. 33 is a flowchart of the fourth embodiment of the connection stability checking method according to the present disclosure.

Referring to FIG. 33, a connection stability checking method may include: calculating a coupling power of a coupling part (S700); determining connection stability between an assembling element and another assembling element (S710); and displaying a color on the basis of the connection stability (S720).

Displaying the color on the basis of the connection stability (S720) may correspond to displaying a color of a connected assembling element 120. In addition, displaying the color on the basis of the connection stability may correspond to displaying a color of a coupling region which is provided by connecting an assembling element 120 to another assembling element 120. In addition, displaying the color on the basis of the connection stability may correspond to displaying a color of a flat surface including the coupling region.

In addition, displaying the color on the basis of the connection stability (S720) may correspond to changing a color by comparing the connection stability with a predetermined value. Color may be variously changed according to connection stability. For example, a color of an assembling element 120 having high connection stability may be displayed to be green. In addition, a color of an assembling element 120 having low connection stability may be displayed to be red.

In addition to color displaying, an assembling toy 1000 having a connection stability problem may be displayed. In this case, the number of assembling toys 1000 having a connection stability problem may be displayed by using characters.

Further, connection stability may be classified into a plurality of states according to the degree of the connection stability and then the classified connection stability may be displayed. In this case, the connection stability may be compared with a first predetermined value and a second predetermined value and may then be displayed to be in a state including at least one of a warning state, a caution state, and a stable state. In this case, a color of an assembling element 120 may be changed according to the magnitude of the connection stability.

The configurations and characteristics of the present disclosure have been described on the basis of the embodiments according to the present disclosure in the above description, but the present disclosure is not limited thereto. Various modifications or changes within the concept and scope of the present disclosure would be obvious to those skilled in the art. Therefore, it is noted that such modifications or changes fall within the scope of the appended claims.

### DESCRIPTION OF REFERENCE SYMBOLS

10: system, 12: controller, 14: memory, 16: input module, 18: display module, 100: virtual space, 102: ground, 104: cell, 110: coupling part, 120: assembling element, 130: body, 200: assembling element palette, 300: assembling element group, 1000: assembling toy

1. A method for checking connection stability of a plurality of assembling elements disposed in a virtual space, each of the plurality of assembling elements having at least one coupling part complementarily coupled to another coupling part and being connected to another assembling element of the plurality of assembling elements through the coupling part, the method comprising:
assigning preset weight information to at least one of the assembling elements of the plurality of assembling elements;
calculating a coupling power of the coupling part in consideration of a coupling type and a coupling number of the coupling part; and
determining connection stability between the at least one assembling element of the plurality of assembling elements and said another assembling element of the plurality of assembling elements on the basis of the coupling power and the weight information assigned to the at least one assembling element of the plurality of assembly elements.

2. The method of claim 1, further comprising grouping, on the basis of the coupling power, the plurality of assembling elements to a first assembling element group including at least one of the plurality of assembling elements.

3. The method of claim 2, wherein the grouping comprises performing grouping by comparing the coupling power and a predetermined value.

4. The method of claim 2, further comprising determining the connection stability between the first assembling element group and a second assembling element group on the basis of the coupling power and weight information assigned to the second assembling element group, wherein the second assembling element group is coupled to the at least one assembling element of the plurality of assembling elements through said another coupling part coupled to the coupling part and is connected to the first assembling element group.

5. The method of claim 2, further comprising displaying a result indicating the connection stability.

6. The method of claim 5, wherein displaying comprises displaying a color of the assembling element group on the basis of the connection stability.

7. The method of claim 5, wherein displaying comprises:
displaying the at least one assembling element of the plurality of assembling elements, which connects the first assembling element group and the second assembling element group, to be in a warning state if the connection stability is smaller than a first predetermined value; and
displaying the at least one assembling element of the plurality of assembling elements, which connects the first assembling element group and the second assembling element group, to be in a caution state if the connection stability is equal to or larger than the first predetermined value and is smaller than a second predetermined value which is larger than the first predetermined value.

8. The method of claim 1, wherein the coupling part comprises at least one of a stud, a cavity, an axle, an axle hole, a technic pin, a technic pin hole, a ball, a ball receptacle, and a hinge.

9. A method for checking balance stability of a plurality of assembling elements disposed in a virtual space, each of the plurality of assembling elements having at least one coupling part complementarily coupled to another coupling part and being connected to another assembling element of the plurality of assembling elements through the coupling part, the method comprising:
calculating a mass distribution assigned to an assembling toy composed of at least one assembling element and all other assembling elements of the plurality of assembly elements connected to at least one assembling element; and
determining balance stability of the assembling toy on the basis of the mass distribution.

10. The method of claim 9, further comprising determining the balance stability in further consideration of whether a mass center of the assembling toy is included in a region perpendicular to a bottom surface of the assembling toy.

11. The method of claim 10, further comprising displaying a result indicating the balance stability.

12. The method of claim 11, wherein displaying comprises displaying a color of a flat surface including the bottom surface of the assembling toy on the basis of the balance stability.

13. The method of claim 11, wherein displaying comprises displaying the bottom surface of the assembling toy to be in a warning state if the balance stability is smaller than a predetermined value.
